(19) United States
(12) Patent Application Publication
(10) Pub. No.: US 2002/0062980 A1
(43) Pub. Date: May 30, 2002

(54) Cable system

(76) Inventors: Cornelis Antonius Agnes Maria Nuyten, Roosendaal (NL); Roy Nienhuis, Winterswijk (NL)

Correspondence Address: YOUNG & THOMPSON, 745 SOUTH 23RD STREET 2ND FLOOR, ARLINGTON, VA, 22202

(21) Appl. No.: 09/990,298

(22) Filed: Nov. 23, 2001

(30) Foreign Application Priority Data
Nov. 23, 2000 (NL) 1016691

(51) Int. Cl. H01B 7/08

(52) U.S. Cl. 174/117 F

(57) ABSTRACT

A cable system comprises a bundle of stacked flat layers, each of which comprises a series of wires insulated from one another, at least two protective layers, each of which is accommodated between two adjacent layers, a common protective sheath that surrounds the bundle, and a conductor that connects the protective layers electrically to one another. The conductor extends transversely between each of the pairs consisting of a protective layer and an adjacent layer

The invention relates to a cable system comprising a bundle of stacked flat layers, each of which comprises a series of wires insulated from one another, at least two protective layers, each of which is accommodated between two adjacent layers, a common protective sheath that surrounds the bundle, and a conductor that connects the protective layers electrically to one another.

A cable system of this type is known. The layers or flat cables thereof comprise a number of electrical wires via which a wide variety of types of signals can be transmitted. In view of the small mutual spacing between the flat cables, the problem of crosstalk can arise with this system. In order to prevent this problem, protective layers are placed between the flat cables.

The protective layers are electrically connected to one another at the location of the connectors which are at the ends of the bundle. The disadvantage of his construction is that the connection of the protective layers has to be made when the connectors are fitted. This is labor intensive and can sometimes lead to defective contacts between the protective layers.

The aim of the invention is to provide a cable system of the type described above with which reliable connection of the protective layers is ensured. This can be achieved in that the conductor extends transversely between each of the pairs consisting of a protective layer aid an adjacent layer.

The result of positioning tie conductor transversely between the layers is that is conductor is in contact with the protective layers over a fairly large surface area, which promotes good electrical contact. This contact can be further improved by compressing the bundle to some extent, for example at the location of the strain relief at a connector. The resistance between the conductor and the protective layers is preferably less than 10 ohm.

A farther advantage is that the conductor can be fitted fairly easily. It must be taken into consideration that the conductor has to be present locally only and thus does not have to extend over the entire length of the cable bundle. In this context the conductor is preferably in ribbon form and runs in a zigzag pattern between the layers.

The conductor can consist of a wide variety of materials that are electrically conducting, but the preference is for a conductor made of a flexible conducting material, for example a conducting polymer or elastomer. Such a flexible material has the advantage that it is easily able to adapt to the surface of the protective layers, so that excellent contact is ensured. Furthermore, any compressive force between the conductor and the protective layer is well distributed, so that the production of compressive stress peaks and any wear phenomena can be prevented.

The contact of the flexible material furthermore promotes good sealing of the contact surfaced between the conductor and the protective layers, such that the ingress of moisture and any chemical fluids which could adversely affect said contact is counteracted.

The conductor can furthermore be made of a composite of plastic and metal. By way of example, the conductor can consist of a plastic covered with metal foil, or a plastic provided with metal wires, such as woven or plaited metal wires.

Preferably there is also a resistance layer between the conductor and the protective sheath. Any static electricity in the cable bundle is able to dissipate via this resistance, whilst, on the other hand, a direct electrical connection between the protective layers and the protective sheath is prevented.

According to a variant, there can be a conductor at both ends of the bundle. With this arrangement the resistance between the protective sheath and the two conductors can be >1 kilohm, or the resistance between the protective sheath and a conductor can be <100 ohm, and between the protective sheath 10 and the other conductor >10 kilolm.

With these possibilities the protective layer always acts as an electrostatic shield for the total bundle with respect to the environment, whilst static electricity is nevertheless able to dissipate.

The invention will now be explained in more detail with reference to an illustrative embodiment shown in the figures.

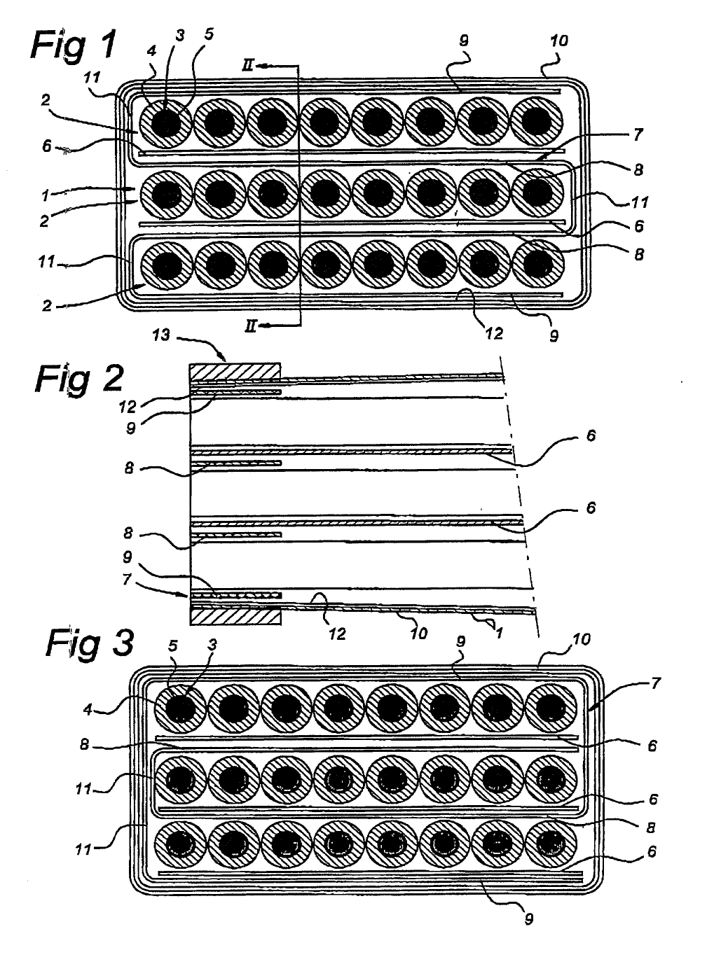

FIG. 1 shows a cross-section through a cable system according to the invention.

FIG. 2 shows a longitudinal section through the cable system.

FIG. 3 shows a cross-section through a variant.

In the cross-section of the cable system according to the invention shown in FIG. 1 a bundle 1 of stacked flat layers 2 is shown, which layers each consist of mutually insulated wires 3 with an insulation layer 4 and an electrical conductor 5. These layers 2 are separated by protective layers 6, in such a way that crosstalk between the electrical conductors 3 of different layers can be prevented.

According to the invention these protective layers 6 are connected to one another by a conductor 7, which extends in zigzag form between the layers 2. The conductor 7 has two inner pays 8, each of which is located between two layers 2, and two outer parts 9 which are located between the outer layers 2 and the protective sheath 10. The parts 8, 9 are connected to one another by cross-pieces 11, as a result of which a single ribbon can be used that runs in zigzag form through the cable bundle 1.

Between the protective sheath 10 and the outer parts 9 there is a resistance layer 12 which has a relatively high resistance, for example at least 1 kΩ. As a result, static electricity is able to dissipate from the protective layer 6 to the protective sheath 10, whilst, on the other hand, direct electrical connection between these components is prevented.

As is shown in FIG. 2, the conductor 7 is located in the cable bundle 1 at the clamping point 13 which, for example, can form part of the strain relief for a connector, which is not further shown. The whole is compressed to some extent at the location of this strain relief 13, in such a way that the conductor 7 is held in good contact with the protective layers 6. If the conductor is made of a conducting polymer material, the latter is also deformed to some extent under the influence of his contact force. As a result the contact effect is even further improved and the contact force is also distributed so that no mechanical peak stresses that are too high, or wear would be produced. A further advantage is that the interior of the cable system is in this way sealed well with respect to the environment, so that the ingress of moisture and chemicals can be substantially avoided.

As shown in FIG. 3, the conductor can also run through the bundle in some other way than in a zigzag pattern. In the embodiment in FIG. 3 the inner parts 8 are connected to one another by a vertical part 11, but the outer parts 9 are also connected to one another by a vertical part 11. The conductor 7 is now wound in one and the same direction about the layers 2 with protective layers 6.

Only one end of the cable system is shown in FIG. 2. In practice a conductor can be provided at one or at both ends of the bundle. In the latter case, the electrical resistance between the protective sheath and the conductor can be, for example, >1 kilohm or at one end >10 kilohm and at the other end <100 ohm.

1. Cable system comprising a bundle (1) of stacked flat layers (2), each of which comprises a series of wires (3) insulated from one another, at least two protective layers (6), each of which is accommodated between two adjacent layers (2), a common protective sheath (10) that surrounds the bundle (1), and a conductor (7) that connects the protective layers (6) electrically to one another, characterised in that the conductor (7) extends transversely between each of the pairs consisting of a protective layer (6) and an adjacent layer (2).

2. Cable system according to claim 1, wherein the conductor (7) runs through the cable bundle (1) in a zigzag pattern.

3. Cable system according to claim 1, wherein the conductor (7) is wound in one and the same direction around the pairs of layers (2) with protective layers (6).

4. Cable system according to claim 2 or 3, wherein the conductor (7) extends as far as over the outer layers (2).

5. Cable system according to one of the preceding claims, wherein the conductor (7) is made of an electrically conducting plastic.

6. Cable system according to claim 5, wherein the plastic is a polymer or an elastomer.

7. Cable system according to claim 5 or 6, wherein the conductor (7) is made of a composite of plastic and metal.

8. Cable system according to claim 7, wherein the conductor (7) is made of a plastic covered with metal foil.

9. Cable system according to claim 7, wherein the conductor (7) is made of a plastic provided with metal wires, such as woven or plaited metal wires.

10. Cable system according to one of the preceding claims, wherein the resistance of the connection between the conductor (7) arid the protective layers is less than 10 Ω.

11. Cable system according to one of the preceding claims, wherein the conductor (7) is in ribbon form.

12. Cable system according to one of the preceding clams, Wherein a resistance layer (12) having a relatively high electrical resistance is located between the conductor (7) and the prospective sheath (10).

13. Cable system according to one of the preceding claims, wherein there is a conductor (7) at both ends of the bundle (1).

14. Cable system according to claim 13, wherein the resistance between the protective sheath (10) and the two conductors (7) is >1 kilohm.

15. Cable system according to claim 13, wherein the resistance between the protective sheath (10) and one conductor (7) is <100 ohm and between the protective sheath (10) and the other conductor is>10 kilohm.

16. Cable system according to one of the preceding claims, wherein there is a connector at at least one of the ends of the bundle, which connector is provided with a strain relief (13), and there is a conductor (7) in that part of the bundle (1) that is clamped in the strain relief (13).
